(19) United States
(12) Patent Application Publication
(10) Pub. No.: US 2018/0281299 A1
(43) Pub. Date: Oct. 4, 2018

(54) Method and System for Compliant Press-Fit Tray Table

(71) Applicant: Reliant Worldwide Plastics, LLC, Plano, TX (US)

(72) Inventor: William H. Maslakow, Plano, TX (US)

(21) Appl. No.: 15/944,015

(22) Filed: Apr. 3, 2018

Related U.S. Application Data
(60) Provisional application No. 62/480,941, filed on Apr. 3, 2017.

(51) Int. Cl. B29C 65/56; A47C 7/70; B60N 3/00; B64D 11/06

(52) U.S. Cl. CPC B29C 65/565; A47C 7/70; B29L 2031/448; B64D 11/0638; B60N 3/004

(57) ABSTRACT

A thermoplastic homogenous tray table assembly includes a top cover and a bottom cover. An injection molded thermoplastic composite reinforced frame assembly with a plurality of compliant press-fit device receptacle apertures is homogenously chemically bonded to the top cover, and a similar frame is formed for the bottom cover. The cover frame assemblies includes a plurality of integral precision recessed alignment features, mate-able to extended precision alignment features of the opposing cover frame assembly. A thermoplastic homogeneous bottom cover is joined, via press fitting, to the top cover utilizing a plurality of compliant press-fit assembly device members.

### PRIORITY

The present invention claims priority to Provisional Patent Application No. 62/480,941 filed Apr. 3, 2017 entitled “Method and System for Compliant Press-Fit Tray Table”, the entirety of which is hereby incorporated by reference.

### BACKGROUND OF THE INVENTION

### Field of the Invention

The present invention relates generally to thermoplastic assemblies and more specifically, but not by way of limitation, to systems and methods for a thermoplastic tray table assembly utilizing compliant press-fit device members.

### History of the Related Art

In the commercial aircraft industry, weight and safety are important issues. Even non-structural and non-critical elements such as tray tables on commercial aircraft should be designed with these in mind. For example, a weight savings on each tray can add up to a fairly significant weight savings for the aircraft as a whole, which in turn may reduce fuel expenditures and thereby provide an operational cost savings. Such reduction must not adversely affect strength.

### SUMMARY

Embodiments of the present invention relate to thermoplastic tray tables utilized in commercial airline industry, and more specifically, the passenger cabin area. Embodiments of the present invention are compatible with all types of tray tables, such as for example, single leaf and bi-fold multi-leaf tray tables. Embodiments of present invention are compatible with integral low density foam systems typically utilized in tray table assemblies.

Embodiments of the present invention are based on the elimination of the assembly processes and materials that induce or introduce weight—adhesive tapes (PSA's), epoxies and other binary and plural component systems all add significant weight during the process to integrate the exterior covers to the thermoplastic frame structure. Embodiments of the present invention address the need for a low cost, low weight alternative to the use of adhesives and other mechanical fasteners, and the processing time and costs required to employ same.

### BRIEF DESCRIPTION OF THE DRAWINGS

For a more complete understanding of embodiments of the present invention and for further objects and advantages thereof, reference may now be had to the following description taken in conjunction with the accompanying drawings in which:

FIG. 1 is perspective view of a tray table assembly according to an exemplary embodiment in one embodiment;

FIG. 2 is an exploded view of the tray table of FIG. 1 showing internal features thereof according to an exemplary embodiment;

FIG. 3 is a cross-sectional view of the tray table of FIG. 1 showing internal features thereof according to an exemplary embodiment;

FIG. 4 is an enlarged cross-sectional view of the tray table of FIG. 3 showing the internal homogenous interfaces and compliant press-fit device member features thereof according to an exemplary embodiment; and

FIG. 5 is a flow diagram illustrating an exemplary process for assembling a tray table with compliant press-fit assembly device members in one embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

A thermoplastic homogenous tray table assembly includes top cover. A thermoplastic composite reinforced frame assembly with a plurality of compliant press-fit device receptacle apertures is homogenously chemically bonded to the top cover. The top cover frame assembly includes a plurality of integral precision recessed alignment features, mate-able to extended precision alignment features of the bottom cover frame assembly.

The tray table assembly further includes a bottom cover. A thermoplastic composite reinforced bottom frame assembly with a plurality of compliant press-fit receptacle apertures is homogenously chemically bonded to the bottom cover. The bottom cover frame assembly includes a plurality of integral precision extending alignment features, mate-able to recessed precision alignment features of the top cover frame assembly. The bottom cover frame assembly is installed to an assembly holding fixture integral to a manual or automated operating press system, with the plurality of compliant press-fit device receptacle apertures upward vertically oriented. A plurality of compliant press-fit assembly device members is provided and press-fit installed into the plurality of apertures of the bottom cover assembly. In a typical embodiment, a length portion of each compliant press-fit device member is vertically press-fit installed into each a receptacle aperture of the bottom cover frame assembly utilizing, for example, a compliant press-fit device member press-fitting tool pressing system. In a typical embodiment, vertical aligning and exposing a remaining portion length of the compliant press-fit device members. In one embodiment the compliant press-fit device has a length, the aperture in the bottom frame comprises a length, and the total length of the press-fit device is greater than the length of the aperture in the bottom frame.

The bottom cover frame assembly with the plurality of vertically exposed compliant press-fit device members is installed to an assembly holding fixture integral to a manual or automated operating press system, with the exposed compliant press-fit device members upward vertically oriented.

The top cover assembly with the plurality of compliant press-fit receptacle apertures, is proximally aligned to the exposed upward vertically oriented portion of the plurality of compliant press-fit device members of the bottom cover frame assembly. Additional precision alignment of the top cover frame assembly and the bottom cover frame assembly is provided by the integral precision alignment features of the top cover frame assembly and the bottom cover frame assembly.

The aligned top cover frame assembly is press-fit installed to the top cover frame assembly exposed upward vertically oriented plurality of compliant press-fit device members of the bottom cover via, for example, a suitable press-fit process, thereby producing a plurality of compliant assembly retention forces throughout the thermoplastic reinforced compliant press-fit tray table assembly to maintain retention of the top cover to the bottom cover.

The compliant press-fit device members can comprise of a specific dimensioned diametric (of, relating to, or consisting of a diameter, hereinafter referred to as “round” body with a length and diameter suitable to a particular application. In various embodiments, the body is further comprised of geometric features that create an angular slope of a specific length with the termination of the sloped length creating a diameter greater than the diameter of device member body. The slope terminates and creates a sharp corner barb type feature at the increased diameter.

In another embodiment, the compliant press-fit assembly device members can comprise flat or formed metallic materials with suitable mechanical properties to suit a particular application. The compliant press-fit assembly device members are comprised of a suitable thickness, width, and length, with integral spring features created through the thickness of the material. The spring features are formed, for example, by the creation of an aperture through a portion of the width and length of the material. The aperture creates remnant beams with a length and width, residing adjacent to the aperture with one beam opposing the other beam. The beam ends are distally connected to the material and comprise an arcing geometry. The beams further create a width greater than the width of the initial material width. The beams deflect inwardly and create a resistive force against the element providing a deflection force. A spring dynamic is created upon the deflection of the beam with an aperture. The dynamic provides retention forces.

The retention forces throughout the thermoplastic composite reinforced tray table assembly can be created by the use of the round device members, flat-formed metallic device members, or a combination of round and flat-formed metallic device members. As the compliant press-fit device members are press-fit installed into the apertures of the composite reinforced frame assembly, retention forces are created. Round device member retention forces are created by the compliancy of the frame assembly composite reinforced material forming about the barb feature during installation. In the case of the flat-formed device member, retention forces area created by the interference of the compliant beam springs into the apertures of the frame assembly.

The advantages and benefits gained by the use of thermoplastic carbon composites in all applicable industries can be realized upon the development of new processes that reduce processing costs but maintain the desired performance and quality levels. The cost of thermoplastic carbon composite high strength-to-weight ratio components and assemblies is tolerable to a limit due to the benefits gained by the use of such materials. A method to reduce processing and assembly times will equate to lower cost components and assemblies increasing the adoption and use of thermoplastic carbon composite components throughout many industries.

In order for thermoplastic carbon composites to be fully adopted for use in high volume applications, a method to reduce the processing and assembly times and associated costs must be developed and be more competitive than other current type systems. A high strength-to-weight tray table assembly with reduced weight and equal or greater mechanical performance will reduce cost and be a competitive alternative to current tray table assemblies.

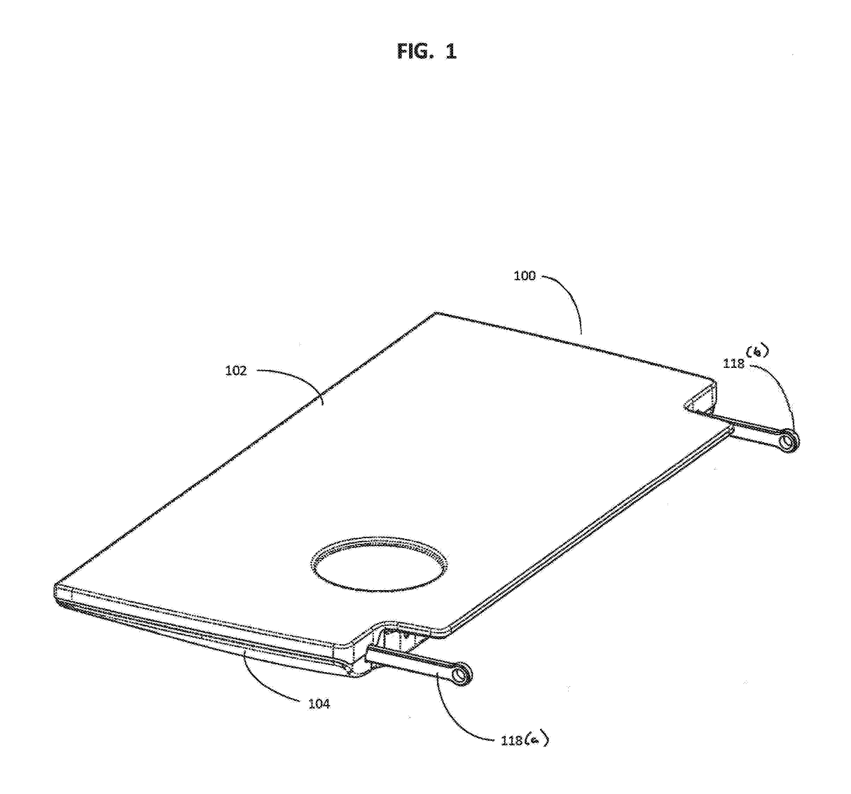

FIG. 1 is perspective view of a tray table assembly 100 in one embodiment. By way of example, the tray table assembly 100 is illustrated in FIG. 1 as including a single-leaf tray table; however, in other embodiments, the tray table assembly 100 can include, for example, a bi-fold tray table or any other type of tray table as dictated by design requirements. The tray table assembly 100 includes a top cover 102 that is joined to a bottom cover 104. In a typical embodiment, the top cover 102 and the bottom cover 104 are constructed of a thermoplastic material. The top cover 102 and the bottom cover 104 can be formed in a variety of methods including thermo-vacuum forming, injection molding, and vacuum pressure forming. A first tray table rod 118(a) and a second tray table rod 118(b) protrude from the top cover 102 and the bottom cover 104. In a typical embodiment, the first tray table rod 118(a) and the second tray table rod 118(b) facilitate attachment of the tray table assembly 100 to a pivot point located on, for example, a rear portion of a seat (not explicitly shown).

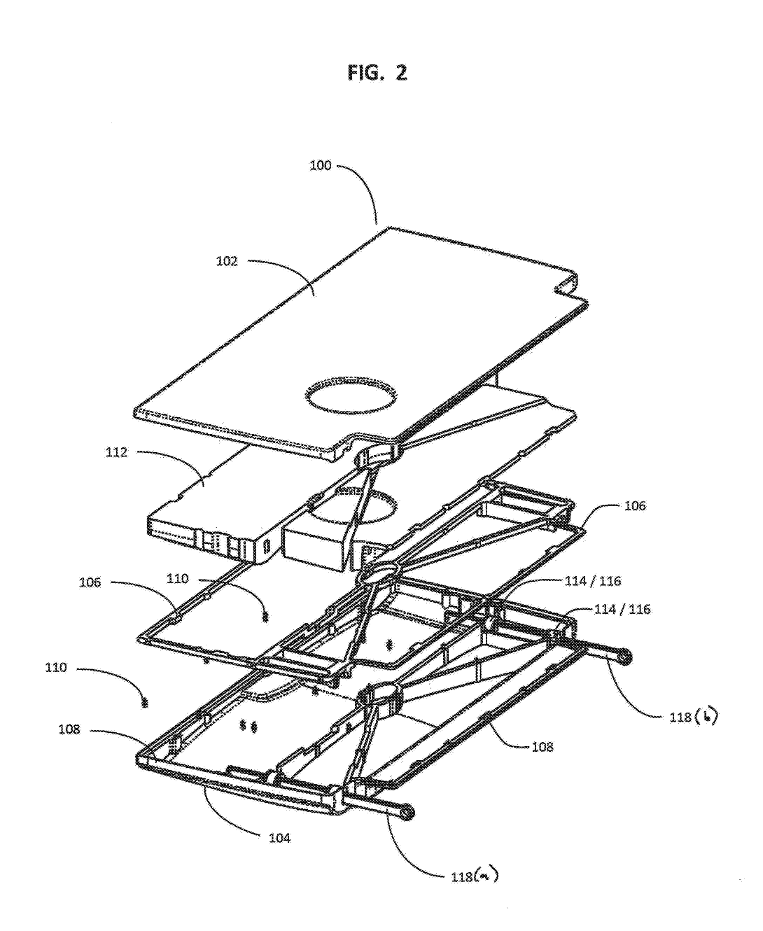

FIG. 2 is an exploded view of the tray table assembly 100 showing internal features thereof in one embodiment. A bottom cover frame assembly 108 is disposed inside the bottom cover 104. In a typical embodiment, the bottom cover frame assembly 108 is a composite-reinforced thermoplastic material that is formed via injection molding, although this is for illustrative purposes only and should not be deemed limiting. The first tray table rod 118(a) and the second tray table rod 118(b) are joined to the bottom cover frame assembly 108 via a plurality of bearings 114 and bearing clips 116. In a typical embodiment, the plurality of bearings 114 and the plurality of bearing clips 116 form a linear bearing or a journal that allows the first tray table rod 118(a) and the second tray table rod 118(b) to slide inwardly and outwardly within the bottom cover frame assembly 108. While one embodiment has been described utilizing bearings and clips, this is for illustrative purposes only and should not be deemed limiting. In other embodiments, for example, the bearings 114 can be retained into the frame assembly via geometric features integral to the frame assembly. One example of this embodiment is the angular features located on the bearing, such as a “V” shape, with the top of the “V” central to the thickness or width of the bearing. In one embodiment, the “V” is taller or thicker in the center of the bearing as compared to the outer edge. A corresponding female “V” is also integral to the frame. Then the bearing 114 is installed into the frame with the bearing being retained by this wider or thicker area central to the bearing thickness. It is interlocked into the frame by the formed “V” feature. One skilled in the art will understand the various other methods of incorporating a bearing and/or clips via geometric design.

Still referring to FIG. 2, in one embodiment the bottom cover frame assembly 108 is joined to the bottom cover 104 via a homogeneous chemical bond. The bottom cover frame assembly 108 includes a plurality of apertures. Each aperture of the plurality of apertures receives a compliant press-fit assembly device member 110. Each compliant press fit assembly device member 110 is received into an aperture in a direction generally perpendicular to a plane parallel to an outer surface of the bottom cover 104 such that a portion of a length of the compliant press-fit assembly device member 110 is received into the aperture and a remainder of the length of the compliant press fit assembly device member 110 protrudes from the aperture. Thus, the bottom cover frame assembly 108 includes a plurality of compliant press-fit assembly device members 110 protruding upwardly therefrom.

Still referring to FIG. 2, a top cover frame assembly 106 is disposed inside the top cover 102. In a typical embodiment, the top cover frame assembly 106 is a composite-reinforced thermoplastic material that is formed via injection molding. As above, this is for illustrative purposes only and should not be deemed limiting. The top cover frame assembly 106 is joined to the top cover 102 via a homogeneous chemical bond. The top cover frame assembly 106 includes a plurality of apertures that correspond to the plurality of apertures formed in the bottom cover frame assembly 108. A foam insert 112 is placed between the top cover 102 and the bottom cover 104. The foam insert 112 includes a plurality of slots formed therein, which slots permit the foam insert 112 to be placed around the top cover frame assembly 106 and the bottom cover frame assembly 108. In a typical embodiment, the foam insert is a low-density foam; however, in other embodiments, foam inserts of any type could be utilized as dictated by design requirements.

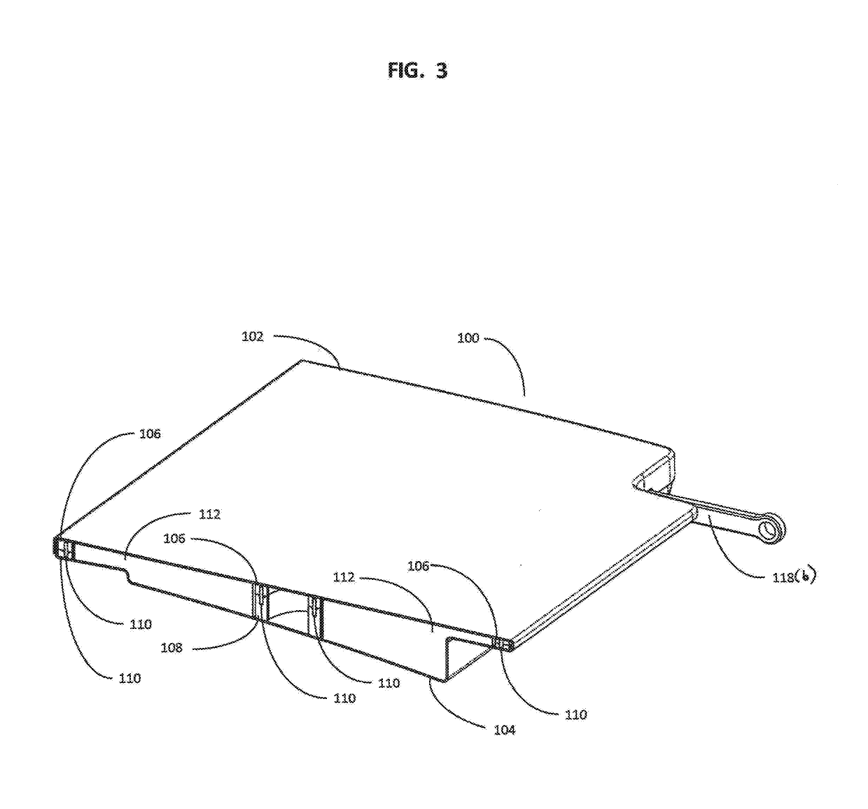

FIG. 3 is a cross-sectional view of the tray table assembly 100 showing internal features thereof in one embodiment. The top cover 102 is homogeneously chemically bonded to the top cover frame assembly 106 and the bottom cover 104 is homogeneously chemically bonded to the bottom cover frame assembly 108. The foam insert 112 fills the gaps in the top cover frame assembly 106 and the bottom cover frame assembly 108. The apertures present in the bottom cover frame assembly 108 align in registry with the apertures of the top cover frame assembly 106. During assembly, an exposed length of the compliant press-fit assembly device members 110 is received into a corresponding aperture of the top cover frame assembly 106 thereby joining the top cover frame assembly 106 to the bottom cover frame assembly 108.

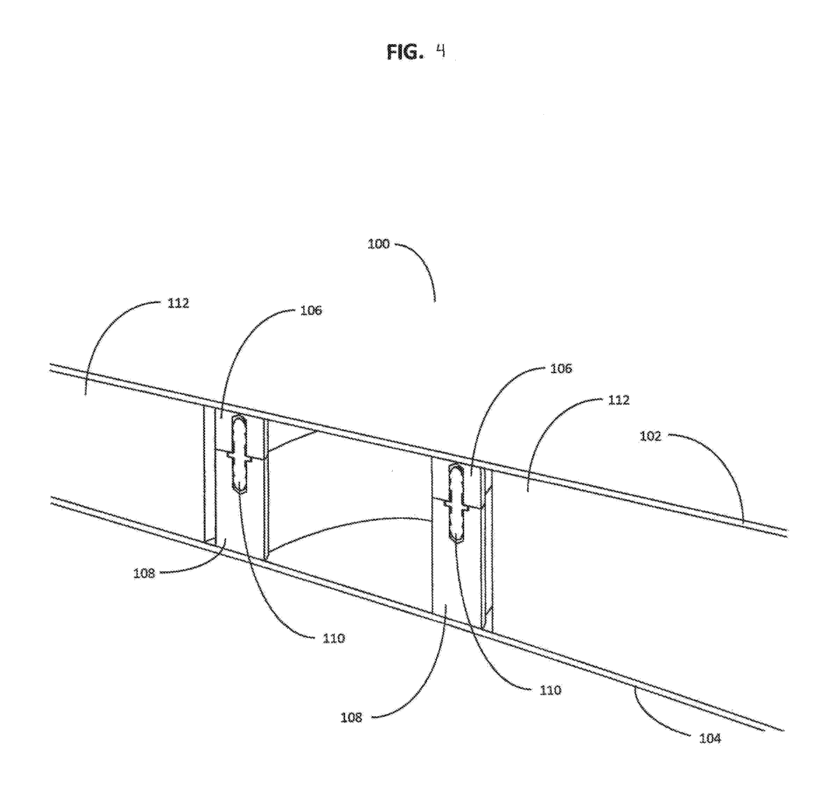

FIG. 4 is an enlarged cross-sectional view of the tray table assembly 100 in one embodiment. The top cover frame assembly 106 is shown joined to the top cover 102 and the bottom cover frame assembly 108 is shown joined to the bottom cover 104. The compliant press-fit assembly device members 110 are received into corresponding apertures formed in the top cover frame assembly 106 and the bottom cover frame assembly 108. The compliant press-fit assembly device members 110 can, in various embodiments, comprise a specific-dimensioned round body with a length and a diameter suitable to the application. The body, in one embodiment, further comprises geometric features that create an angular slope of a specific length with the termination of the sloped length creating a diameter greater than the diameter of device member body. The slope terminates and creates a sharp corner barb type feature at the increased diameter.

In another embodiment, the compliant press-fit assembly device members 110 can comprise flat or formed metallic materials with suitable mechanical properties to suit the application. The compliant press-fit assembly device members 110 comprise a suitable thickness, width and length, with integral spring features created through the thickness of the material. The spring features are formed by the creation of an aperture through a portion of the width and length of the material. The aperture creates remnant beams with a length and width, residing adjacent to the aperture with one beam opposing the other beam. The beam ends are distally connected to the material and comprise an arcing geometry. The beams further create a width greater than the width of the initial material width. The beams deflect inwardly and create a resistive force against the element providing the deflection force. A spring dynamic is created upon the deflection of the beam with an aperture. The dynamic provides retention forces.

The retention forces throughout the thermoplastic composite reinforced tray table assembly 100 can be created by the use of the round device members, flat-formed metallic device members, or a combination of round and flat-formed metallic device members.

As the compliant press-fit assembly device members 110 are press-fit installed into the apertures of the composite reinforced frame assembly, retention forces are created. Round device member retention forces are created by the compliancy of the frame assembly composite reinforced material forming about the barb feature during installation. In the case of the flat-formed compliant press-fit assembly device member 110, retention forces area created by the interference of the compliant beam springs into the apertures of the top cover frame assembly 106 and the bottom cover frame assembly 108.

Embodiments are based on the elimination of the assembly processes and materials that induce or introduce weight—adhesive tapes (PSA's), epoxies and other binary and plural component systems all add significant weight during the process to integrate the exterior covers to the thermoplastic frame structure. Certain embodiments allow the integration of multiple components into one homogenous assembly, providing consistent and repeatable positioning of same. Integration on a homogenous level also increases mechanical performance of the total assembly.

In the case of a Bi-Fold Tray Assembly, for example, there are four (4) covers that need to be affixed to the internal frame support assembly. The typical and most widely used method is the use of Pressure Sensitive Adhesive (PSA) Tapes or Binary/Plural Component epoxy. The current size of a typical Bi-Fold Tray, for example can exceed 17.5″ long×5″ wide. The amount of PSA required (area) can exceed 350 square inches for all four (4) covers. The weight of 350 square inches of PSA can exceed 85 grams or 3 ounces. Typically, large sheets of PSA are utilized as the PSA must capture all flat surfaces of the cover. This is due to the need to capture the integral foam inserts used and to minimize or eliminate the movement of the cover. The PSA is also, in some cases, utilized to enhance structural performance of the tray table assembly by providing an additional level of rigidity, although this is a minimal benefit.

A comparable weight of an adequate number of compliant press-fit assembly device members 110 for a Bi-Fold Tray Assembly is 5 grams. A potential weight saving in excess of 80 grams per tray table assembly can be realized. Additional weight savings can be achieved by the use of thermoplastic carbon reinforced frame assemblies. The cumulative weight reduction by eliminating heavy adhesives, fasteners and through the use of high strength-to-weight ratio materials can be significant.

During assembly, a top thermoplastic cover 102 is provided. The top cover 102 is formed via the methods discussed above, for example, thermo-vacuum forming, vacuum pressure forming, or injection molding. In various embodiments, the top cover 102 requires a secondary trimming process to remove excess materials remaining after the thermo-vacuum forming operation. The trimming operation provides a precision dimensioned thermo-vacuum formed thermoplastic top cover 102.

A bottom thermoplastic cover 104 is provided. The bottom cover 104 is formed via the methods discussed above, as an example. In various embodiments, the bottom cover 104 requires a secondary trimming process to remove excess materials remaining after the thermo-vacuum forming operation. The trimming operation provides a precision dimensioned thermo-vacuum formed thermoplastic bottom cover 104.

The top cover 102 and the bottom cover 104 further comprise an outer surface and an inner surface. The outer surface is typically provided with a suitable and visible texture. In a typical embodiment, the inner surface is typically formed with a smooth surface. The top cover 102 and the bottom cover 104 are installed into an injection mold tool. In a typical embodiment, the injection mold tool is geometrically configured to create an application-specific integral support structure. The top cover 102 and the bottom cover 104 are installed into the injection mold tool with the inner surface exposed. In a typical embodiment, the outer surface of the top cover 102 and the bottom cover 104 is retained within the injection mold tooling.

The injection mold tool provides an injection molding processes whereby a thermoplastic carbon or glass reinforced frame assembly is homogenously chemically bonded to the exposed inner surface of the top cover 102 and the bottom cover 104, creating a top cover frame assembly 106 and a bottom cover frame assembly 108. The top cover frame assembly 106 further comprises a plurality of integral precision recessed alignment features, which are mate-able to extended precision alignment features of the bottom cover frame assembly 108. The bottom cover frame assembly 108 further includes a plurality of integral precision extending alignment features, mate-able to recessed precision alignment features formed in the top cover frame assembly 106.

The injection mold tool additionally includes tooling elements that create apertures in the top cover frame assembly 106 and the bottom cover frame assembly 108. The apertures are geometrically configured to accept a compliant press-fit assembly device member 110. In a typical embodiment, the apertures can be a round form, or a square or rectangle form with suitable depth.

In a typical embodiment, a top and bottom cover frame assembly holding fixture is provided. The fixture is geometrically configured to match the outer surface of the top cover 102 and the bottom cover 104. The bottom cover 104 with the bottom cover frame assembly 108 joined thereto is installed to an assembly holding fixture integral to a manual or automated operating press system, with the plurality of compliant press-fit device receptacle apertures upward vertically oriented. A plurality of compliant press-fit assembly device members 110 is provided and press-fit installed into the plurality of apertures of the bottom cover frame assembly 108. In a typical embodiment, a length portion of each compliant press-fit assembly device member 110 is vertically press-fit installed into each receptacle aperture of the bottom cover frame assembly 108 utilizing, for example, a compliant press-fit device member press-fitting tool pressing system such that the compliant press-fit assembly device members 110 are vertically aligned and exposing a remaining portion length of the compliant press-fit assembly device members 110.

The bottom cover frame assembly 108 with the plurality of vertically exposed compliant press-fit assembly device members 110 is installed to an assembly holding fixture integral to a manual or automated operating press system, with the exposed compliant press-fit assembly device members 110 upward vertically oriented. In various embodiments, an additional assembly step can be provided to include installation of, for example tray table rods 118(a)-(b), bearings 114 and bearing clips 116 into at least one of the top cover frame assembly 106 and the bottom cover frame assembly 108 dependent upon the application.

The top cover frame assembly 106 with the plurality of compliant press-fit receptacle apertures, is proximally aligned to the exposed upward vertically oriented portion of the plurality of compliant press-fit assembly device members 110 of the bottom cover frame assembly 108. In various embodiments, additional precision alignment of the top cover frame assembly 106 and the bottom cover frame assembly 108 is provided by the integral precision alignment features of the top cover frame assembly 106 and the bottom cover frame assembly 108.

The aligned top cover 102 with the top cover frame assembly 106 joined thereto is press-fit installed to the bottom cover frame assembly 108 exposed upward vertically oriented plurality of compliant press-fit assembly device members 110 of the bottom cover frame assembly 108 via, for example, a suitable press-fit process. In a typical embodiment, the press-fit process produces a plurality of compliant assembly retention forces throughout the thermoplastic reinforced compliant press-fit tray table assembly 100 to maintain retention of top cover frame assembly 106 to the bottom cover frame assembly 108. Subsequent sealing operations to the mating edge joints of the top cover 102 and the bottom cover 104 can be provided as needed to meet application requirements.

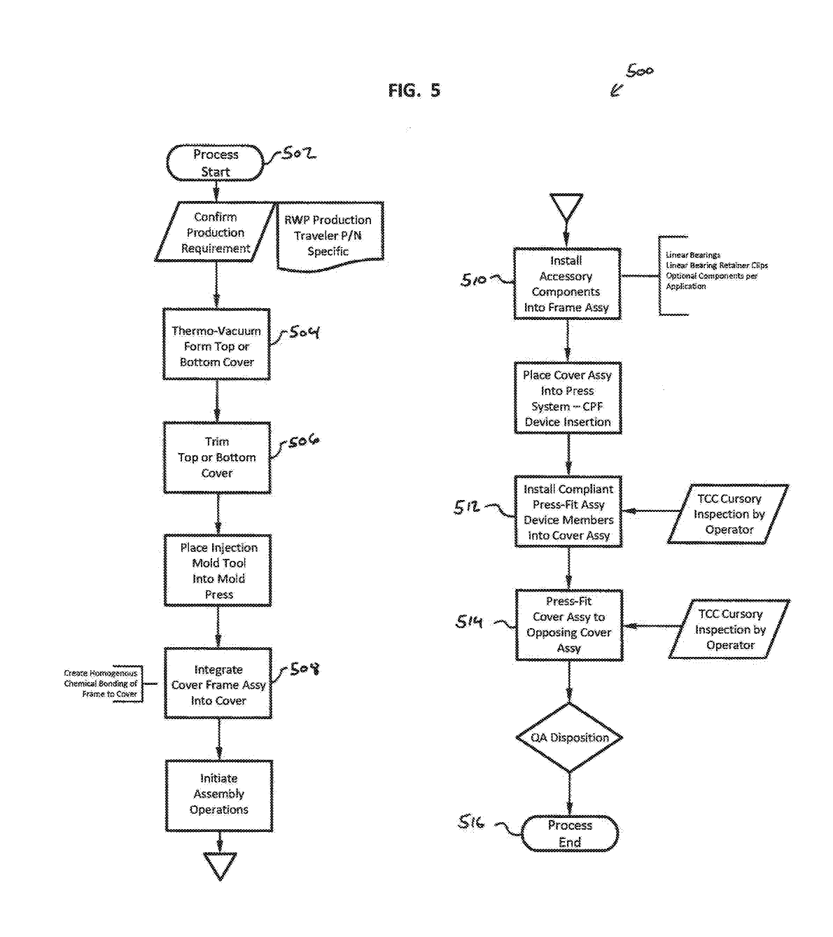

FIG. 5 is a flow diagram illustrating an exemplary process 500 for assembling a tray table assembly 100 utilizing compliant press-fit assembly device members 110 in one embodiment. The process 500 begins at step 502. At step 504, the top cover 102 and the bottom cover 104 are formed via the methods discussed herein, for example, thermo-vacuum forming, which includes heating and forming thermoplastic material at less-than-ambient pressure (e.g. vacuum pressure). In other embodiments, however, other thermoforming processes could be, for example, pressure thermoforming, or any other type of thermoforming process as dictated by design requirements. At step 506, the top cover 102 and the bottom cover 104 are trimmed to remove any excess material that can be present as a result of the forming process. At step 508, the top cover frame assembly 106 is integrated with the top cover 102 so that a homogeneous chemical bond is formed between the top cover frame assembly 106 and the top cover 102. Also, at step 508, the bottom cover frame assembly 108 is integrated with the bottom cover 104 so that a homogeneous chemical bond is formed between the bottom cover frame assembly 108 and the bottom cover 104. At step 510, accessory components such as, for example, the first tray table rod 118(a), the second tray table rod 118(b), bearings 114, and bearing clips 116 are installed into at least one of the top cover frame assembly 106 and/or the bottom cover frame assembly 108. At step 512, a plurality of compliant press-fit assembly device members 110 are installed into apertures in the bottom cover frame assembly 108. At step 514, the top cover frame assembly 106 and the bottom cover frame assembly 108 are joined via, for example, press fitting. The press fitting described in step 514 causes the compliant press-fit assembly device members 110 to be received into corresponding apertures formed in top cover frame assembly 106. Thus, the top cover frame assembly 106 is joined to the bottom cover frame assembly 108 via the compliant press-fit assembly device members 110. The process ends at step 516.

Embodiments of the present invention include chemical and molecular compatible thermoplastic resins throughout the assembly creating an infinite number of homogeneous connective attachments that provide additional strength, dimensional stability, and rigidity. In addition, embodiments, of the present invention provide increased mechanical load-bearing capabilities via the integral formed thermoplastic carbon or glass reinforced composite injection molded into the thermoplastic formed cover. Embodiments reduce the current weight of a comparable tray table assembly by eliminating the assembly processes and materials that introduce weight such as, for example, adhesive tapes, epoxies, or other binary and plural component systems. Additionally, use of high strength-to-weight ratio thermoplastic materials and composites also results in embodiments described herein having a lower weight than comparable tray table assemblies. Embodiments described herein will reduce manufacturing costs through the use of homogeneous integration of the thermoplastic internal support structure and through the elimination of scrap rejections inherent with current production processes.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A tray table comprising:
a top cover joined to a bottom cover, wherein the bottom cover is opposite the top cover;
a bottom frame assembly disposed inside the bottom cover, wherein the bottom frame assembly is joined to the bottom cover via a homogenous chemical bond;
a top frame assembly disposed inside the top cover, wherein the top frame assembly is joined to the top cover via a homogenous chemical bond;
wherein the bottom frame assembly and the top frame assembly each comprises a plurality of apertures, and wherein the plurality of apertures in the bottom frame align with the plurality of apertures in the top frame; and
a plurality of compliant press-fit members which each fit in an aperture on the bottom frame and an aligned aperture on the top frame.

2. The tray table of claim 1 further comprising a foam insert between the top cover and the bottom cover.

3. The tray table of claim 2 wherein said foam comprises a plurality of slots to accommodate the top frame assembly and the bottom frame assembly.

4. The tray table of claim 1 wherein at least one of said plurality of compliant press-fit members is generally perpendicular to a plane parallel to an outer surface of the bottom cover.

5. The tray table of claim 1 wherein at least one of said compliant press-fit members comprises a total length, and wherein an aligned aperture on the bottom frame comprises a length, and wherein the total length of the compliant press-fit is greater than the length of the aligned aperture.

6. The tray table of claim 1 wherein said top frame and said bottom frame each comprise a thermoplastic composite reinforced frames.

7. The tray table of claim 1 wherein at least one of said press-fit members comprises a maximum diameter, and wherein an associated aperture in said top frame comprises a diameter, and wherein the maximum diameter of the press-fit member is greater than the diameter of the associated aperture.

8. The tray table of claim 7 wherein said at least one press-fit member comprises a length and a barb, wherein the barb which exceeds the diameter of the aperture and which is perpendicular to the length of the press-fit member.

9. The tray table of claim 1 which does not comprise a pressure sensitive adhesive or epoxies.

10. The tray table of claim 1 further comprising a first and second tray table rod.

11. The tray table of claim 1 wherein said top cover and said bottom cover comprise a thermoplastic material, and wherein said top frame assembly and said bottom frame assembly comprise a composite-reinforced thermoplastic material.

12. A method of making a tray table, said method comprising:
a) installing a top cover and a bottom cover into a molding tool;
b) creating a top cover frame which is joined to the top cover via a homogenous chemical bond, wherein said top cover frame comprises at least one aperture;
c) creating a bottom cover frame which is joined to the bottom cover via a homogenous chemical bond, wherein said bottom cover frame comprises at least one aperture;
d) installing at least one compliant press-fit member into said at least one aperture in the top cover frame and the at least one aperture in the bottom cover frame.

13. The method of claim 12 wherein said installing of step d) comprises installing the at least one compliant press-fit member into the at least one aperture on the bottom cover frame, such that the compliant press-fit member is partially exposed.

14. The method of claim 13 further comprising positioning the top cover frame so that at least one aperture in the top cover frame aligns with the at least one compliant press-fit member which is partially exposed, and pressing the top cover and the bottom cover together such that the complaint press-fit member is installed in the at least one aperture in the top cover frame.

15. The method of claim 14 wherein pressing comprises using a press-fit operation.

16. The method of claim 12 further comprising installing accessory components.

17. The method of claim 12 wherein said top cover and said bottom cover are formed via thermo-vacuum forming.

18. The method of claim 12 wherein said top cover and said bottom cover are formed via injection molding.

19. The method of claim 17 wherein said top cover and said bottom cover are formed via vacuum pressure forming.
